(19) United States
(12) Patent Application Publication
(10) Pub. No.: US 2010/0002678 A1
(43) Pub. Date: Jan. 7, 2010

(54) MOBILE RADIO TERMINAL AND RADIO COMMUNICATION METHOD

(75) Inventors: Shigeo Terabe, Hachioji-shi (JP); Yutaka Asanuma, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/166,440

(22) Filed: Jul. 2, 2008

(51) Int. Cl. H04J 3/06

(52) U.S. Cl. 370/350

(57) ABSTRACT

A transmitter executes the transmission using the synchronization signal in which a plurality of blocks formed of the synchronization code sequences different from each other are aligned in the order changed in the former part and the latter part while a receiver comprises the delay detection circuit corresponding to the delayed correlation base system and the replica base detection circuit corresponding to the replica base system corresponding to the synchronization signal, to execute the synchronization detection selectively in the replica base system or the delayed correlation base system.

### BACKGROUND OF THE INVENTION

1. Field of the Invention

The present invention relates to a mobile radio terminal employed for, for example, a cellular telephone system.

2. Description of the Related Art

Two methods for synchronization in a mobile radio terminal of a radio cellular system have been proposed. One of the methods is to preliminary store a synchronization code in a mobile radio terminal as a replica (known code) and detect cross-correlation employing a matched filter in a time domain by using the replica (hereinafter called replica base system) (cf., for example, “Spread Spectrum Communication System” written by Mitsuo YOKOYAMA, Kagaku-Guijutsu Publishing Co., 1988). As for the replica base system, a problem that the power consumption is great since the circuit size of the matched filter is large and the calculation amount is great, is known.

The other method is to repeatedly locate the same signal waveforms in a synchronization code and detect the synchronization timing by delayed autocorrelation (hereinafter called delayed correlation base system) (cf., for example, “Spread Spectrum Communication System” written by Mitsuo YOKOYAMA, Kagaku-Guijutsu Publishing Co., 1988). The delayed correlation base system has a merit that the circuit size is small and the calculation amount is small but also has a demerit that the detection of the synchronization spends much time since SN of a correlation value obtained from a synchronization signal of the same electric power is generally small as compared with the replica base system.

The synchronization code used in the replica base system is required to have a sharp autocorrelation peak at the synchronization timing and to be autocorrelation having a small absolute value at the other time shift. On the other hand, the synchronization code used in the delayed correlation base system is required to have the same signal waveform located repeatedly therein. Therefore, the conditions required for the two synchronization codes are generally contradictory.

For this reason, the mobile radio terminal needs to employ the delayed correlation base system of a small power consumption if the mobile radio terminal is a low-end terminal, while the mobile radio terminal needs to employ the replica base system by considering the synchronization performance rather than the power consumption if the mobile radio terminal is a high-end terminal. Thus, the mobile radio terminal is required to correspond to two different synchronization processes by a single system.

### BRIEF SUMMARY OF THE INVENTION

The present invention has been accomplished to solve the above-described problems. The object of the present invention is to provide a mobile radio terminal and radio communication method capable of establishing synchronization using a synchronization signal corresponding to two different synchronization processes.

To achieve this object, an aspect of the present invention is a mobile radio terminal in which a synchronization signal multiplexed on a transmission signal consists of at least four blocks A, B, C, D, timely preceding two blocks A, B consist of synchronization code sequences different from each other, two blocks C, D follow the blocks A, B, the block C consists of the same synchronization code sequence as the block B, the block D consists of the same synchronization code sequence as the block A, and reception is executed by establishing synchronization based on the synchronization signal. The terminal comprises: a first detecting unit which obtains a chip phase of a reception signal down-converted to a baseband, by delayed correlation, and detects a synchronization timing used for reception; a second detecting unit which obtains the chip phase of the reception signal down-converted to the baseband, by a correlation with a prestored replica signal, and detects a synchronization timing used for reception; and a control unit which selectively operates at least one of the first detecting unit and the second detecting unit.

As described above, a synchronization signal multiplexed on a transmission signal consists of at least four blocks A, B, C, D, timely preceding two blocks A, B consist of synchronization code sequences different from each other, two blocks C, D follow the blocks A, B, the block C consists of the same synchronization code sequence as the block B, the block D consists of the same synchronization code sequence as the block A, so as to selectively execute the detection of the synchronization timing caused by the delayed correlation and the detection of the synchronization timing using the replica signal.

Therefore, the present invention can provide a mobile radio terminal and radio communication method capable of establishing synchronization in both the replica base system and the delayed correlation base system, and suppressing the correlation level at an erroneous timing and achieving a high synchronous detection accuracy in any one of the systems.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a configuration of a transmitter in a radio communication system according to an embodiment of this invention;

FIG. 2 is a block diagram showing a configuration of a receiver in a radio communication system according to an embodiment of this invention;

FIG. 3 is an illustration showing a structure of a synchronization signal used by the transmitter shown in FIG. 1;

FIG. 4 is an illustration showing another structure of a synchronization signal used by the transmitter shown in FIG. 1;

FIG. 5 is a block diagram showing a configuration of a timing detecting unit in the receiver shown in FIG. 2;

FIG. 6 is a block diagram showing a configuration of a delay detection circuit in the timing detecting unit shown in FIG. 5;

FIG. 7 is a block diagram showing a configuration of a replica base detection circuit in the timing detecting unit shown in FIG. 5;

FIG. 8 is an illustration showing a structure of a synchronization signal used by a conventional transmitter;

FIG. 9 is a graph showing a detection result of autocorrelation level in a conventional replica base system using the synchronization signal shown in FIG. 8;

FIG. 10 is a graph showing a detection result of autocorrelation level according to a replica base detection circuit shown in FIG. 8;

FIG. 11 is a graph showing a detection result of autocorrelation level in a conventional delayed correlation base system using the synchronization signal shown in FIG. 8; and

FIG. 12 is a graph showing a detection result of autocorrelation level according to the delay detection circuit shown in FIG. 6.

### DETAILED DESCRIPTION OF THE INVENTION

An embodiment of the present invention is described with reference to the accompanying drawings.

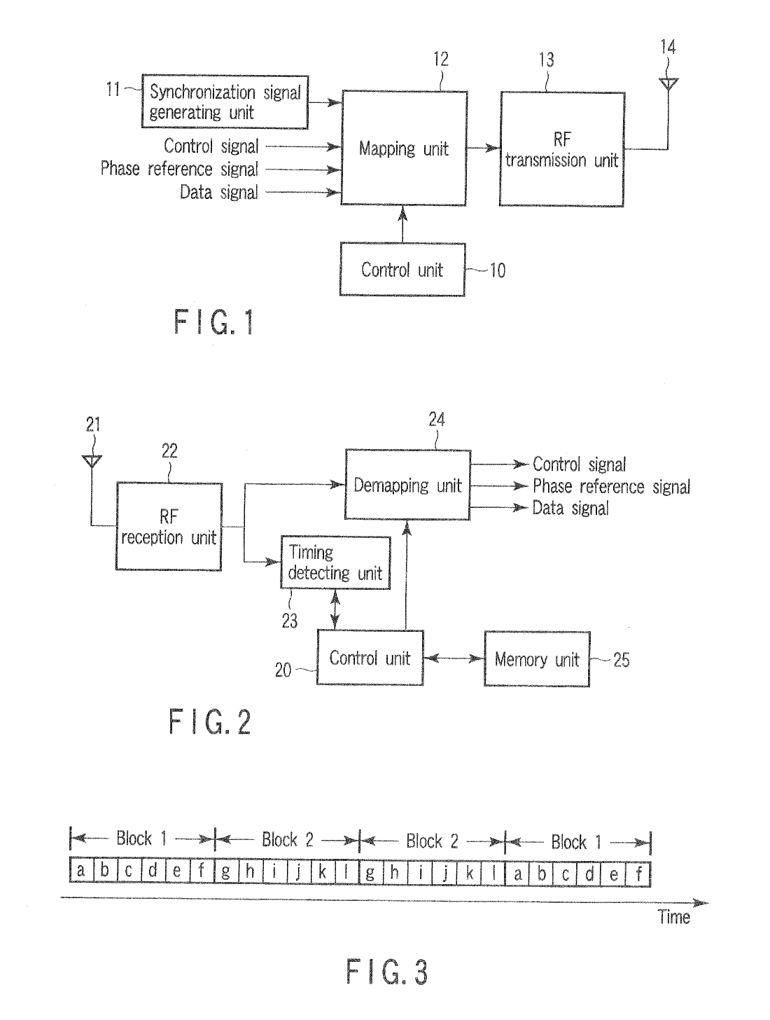

The radio communication system according to this invention comprises a plurality of transmitters and a plurality of receivers. Each of the receivers establishes communications with one of the transmitters that is closest (with the greatest receiving signal power). Each of the transmitters has a configuration as shown in FIG. 1, and periodically inserts a synchronization code into each of the transmitted signals. In addition, each of the receivers has a configuration as shown in FIG. 2. To establish synchronization with the desired transmitter, the receiver obtains a correlation value for all the chip phases within a transmission cycle of the synchronization code, discriminates that the transmitter which can obtain the greatest correlation peak is the closest transmitter, on the basis of the obtained correlation value, and extracts a symbol timing from the peak position.

First, the configuration of the transmitter according to this invention is described. The transmitter comprises a control unit 10, a synchronization signal generating unit 1, a mapping unit 12, an RF transmission unit 13, and an antenna 14.

The synchronization signal generating unit 11 generates a synchronization signal to allow the receiver to receive the signal transmitted from the transmitter. A configuration of the synchronization signal is shown in FIG. 3. In FIG. 3, one frame corresponds to one symbol of the synchronization code sequence used in one chip time. In the synchronization signal, the synchronization code sequence is associated with each of the consecutive chip times.

In the synchronization signal generated by the synchronization signal generating unit 11, one block consists of a determined number (6 in FIG. 3) of consecutive synchronization code sequences, a determined number (2 in FIG. 3) of blocks which consist of different synchronization code sequences are consecutive as a former part, and the order of the consecutive blocks is changed and the blocks are added as a latter part following the former part. In other words, the configured synchronization code sequences have a sequence length which is twice as great as the original synchronization code sequence (two blocks in FIG. 3). The order of the synchronization code sequences constituting each of the blocks constituting the latter part is the same as that of the synchronization code sequences constituting each of the blocks constituting the former part.

In the example shown in FIG. 3, the synchronization code sequence {a, b, c, d, e, f} referred to as block 1 and the synchronization code sequence {g, h, i, j, k, l} referred to as block 2 are consecutive and consist of the former part. As the latter part following the consecutive block 1 and block 2, the block 2 and the block 1 are consecutive and consist of 6×4 synchronization code sequence. Each of “a”, “b”, “c”, “d”, “e”, “f”, “g”, “h”, “i”, “j”, “k” and “l” represents one code of the synchronization code sequence of one chip time.

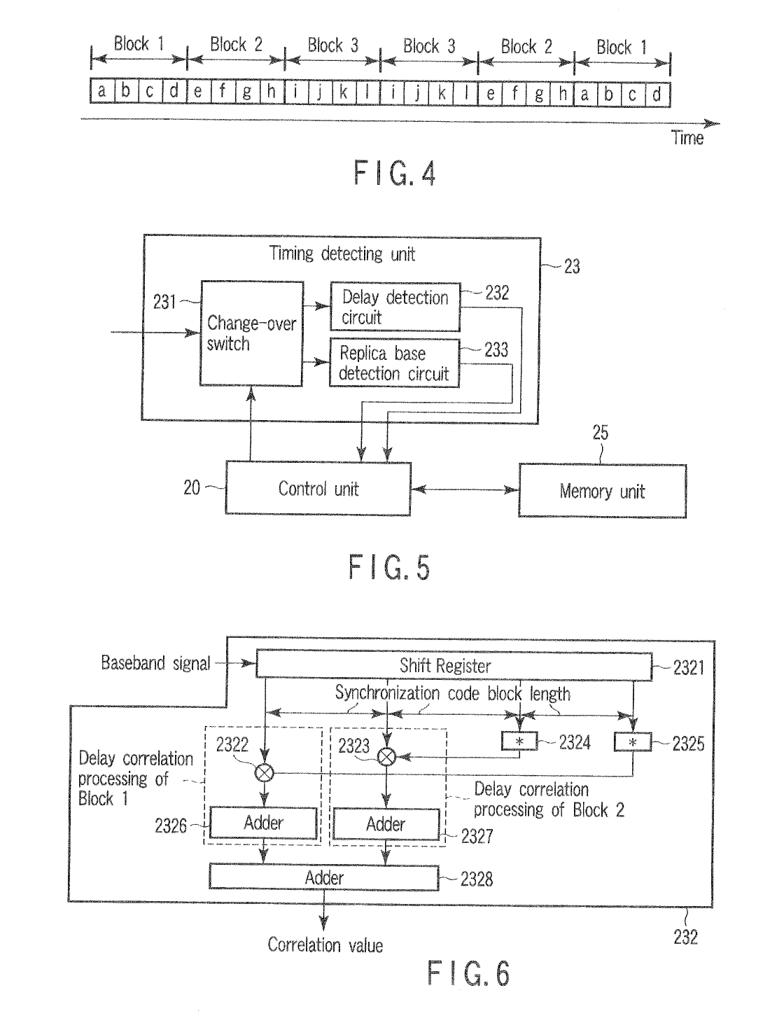

If four synchronization code sequences consist of one block and three types of blocks, i.e. totally six blocks consist of the synchronization signal, with the same synchronization code sequence length as the above example, the synchronization signal may be constituted as shown in FIG. 4. In other words, three different blocks 1, 2, 3 are used by constituting one block of four chips. These blocks are aligned in the order of “1”, “2”, “3”, “3”, “2”, “1” to constitute the synchronization code sequences.

The mapping unit 12 multiplexes the synchronization signal generated by the synchronization signal generating unit 11 in the above manner with the other signals (control signal, phase reference signal, data signal and the like), in a cycle directed by the control unit 10. As the multiplexing method, time multiplexing or code multiplexing such as CDMA (Code Division Multiple Access) can be applied.

The control unit 10 controls multiplexing of the mapping unit 12 such that the synchronization signal in a predetermined cycle. The RF transmission unit 13 modulates a carrier with the signal multiplexed by the mapping unit 12 and emits the modulated carrier to space via the antenna 14.

Next, the configuration of the receiver according to this invention is described. The receiver comprises a control unit 20, an antenna 21, an RF reception unit 22, a timing detecting unit 23, a demapping unit 24, and a memory unit 25.

The RF reception unit 22 is configured to receive the RF signal transmitted from the above-described transmitter via the antenna 21, and down-converts and demodulates the received RF signal to obtain a baseband signal. The baseband signal is output to the timing detecting unit 23 and the demapping unit 24.

The timing detecting unit 23 obtains the correlation values of all the chip phases in the synchronization code cycle of the baseband signal, detects the peak of the correlation values, and thereby detects a symbol timing of the transmitter in the vicinity.

A configuration of the timing detecting unit 23 is shown in FIG. 5. The timing detecting unit 23 comprises a change-over switch 231, a delay detection circuit 232, and a replica base detection circuit 233. The change-over switch 231 selectively outputs the input baseband signal to the delay detection circuit 232 or the replica base detection circuit 233, under a direction of the control unit 20.

First, the delay detection circuit 232 is explained. The delay detection circuit 232 is configured to obtain the correlation value of the baseband signal in the delayed correlation base system, and comprises a shift register 2321, multipliers 2322, 2323, conjugate units 2324, 2325 and adders 2326, 2327, 2328 as shown in FIG. 6 to obtain the correlation value for the synchronization signal having the configuration as shown in FIG. 3.

The shift register 2321 is configured to correspond to the synchronization signal inserted into the transmitted signal at the transmitter, and consists of number “block length (m)”×“block number (n−1)” of registers. With the synchronization signal shown in FIG. 3, the shift register 2321 consists of number “6 (=m)”×“3 (=n−1)” of registers.

The shift register 2321 stores the baseband signals in the registers by quantity corresponding to the synchronization signal of one chip. When the baseband signals of one chip are newly input, the shift register 2321 outputs and stores the baseband signals in the first register as the first baseband signals, and shifts the baseband signals of one chip which have been already stored to the adjacent register.

In addition, the shift register 2321 makes an output corresponding to length m of the blocks included in the synchronization signal. In a case where the synchronization signal is formed of 4 blocks, each time the baseband signals of one chip are newly input, the shift register 2321 outputs the baseband signals which have been stored in the m×1-th, m×2-th and m×3-th registers. In the case of the synchronization signal shown in FIG. 3, each time the baseband signals of one chip are newly input, the shift register 2321 outputs the input baseband signals of one chip, and the baseband signals which have been stored in the 6×1-th, 6×2-th and 6×3-th registers.

“p-th” corresponds to the elapsing time after inputting in the shift register 2321. As the value is greater, it indicates that the inputting has been previously made; the “first” is the most recent input.

In other words, in the case where the baseband signals using the synchronization signal shown in FIG. 3 are input, the baseband signal input to the first register is output together with the baseband signals which are stored in the 6×1-th, 6×2-th and 6×3-th registers when 6×3 chips have elapsed and all the registers are filled with the baseband signals after the start of input of the baseband signals.

The conjugate units 2324, 2325 obtain complex conjugates of the baseband signals output from the 6×2-th register and the 6×3-th register, respectively. The multiplier 2322 multiplies the first input baseband signal by the complex conjugates of the 6×3-th synchronization signal output from the conjugate unit 2325 and obtains a correlation therebetween. Similarly, the multiplier 2323 multiplies the baseband signal output from the 6×1-th register by the complex conjugates of the 6×2-th synchronization signal output from the conjugate unit 2324 and obtains a correlation therebetween. The correlation level is indicated by the vector level.

The adder 2326 executes cumulative addition of the correlation value obtained by the multiplier 2322, by block length m, and outputs the addition result each time the baseband signals of one chip are input to the shift register 2321. Similarly, the adder 2327 executes cumulative addition of the correlation value obtained by the multiplier 2323, by block length m, and outputs the addition result each time the baseband signals of one chip are input to the shift register 2321. The adder 2328 converts the addition results obtained by the adder 2326 and the adder 2327 into powers, adds the converted powers, and output the addition result to the control unit 20 as a correlation value of this time.

The results of the delay detection of the blocks can be subjected to vector addition. The phase rotation amounts of the respective correlation values are used for the vector addition since the ratio of the time interval between the blocks is known. In FIG. 3, since two sets of block 1 are separated with a time interval three times as great as two sets of block 2, vector addition is executed by considering that the phase rotation which is three times as great as the phase rotation in the block 2 is added to the entire block 1. Thus, the SN of the correlation value can be enhanced and the synchronization time can be reduced.

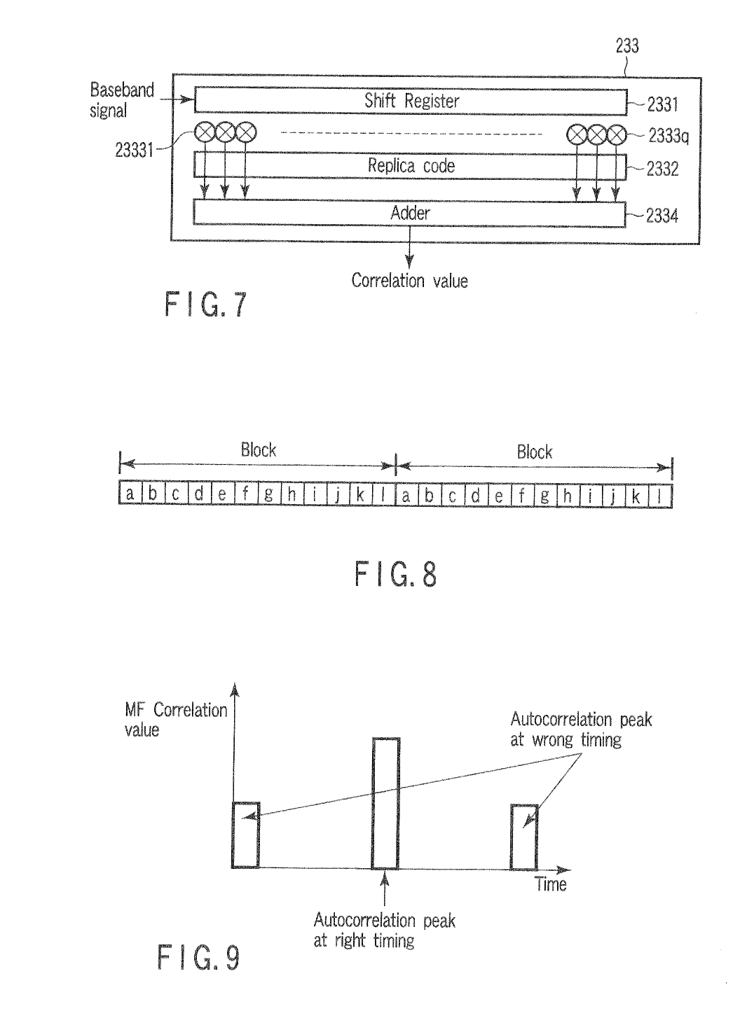

Next, the replica base detection circuit 233 is described. The replica base detection circuit 233 is configured to obtain the correlation value of the baseband signals in the replica base system, and comprises a shift register 2331, a replica code storing unit 2332, multipliers 23331 to 2333q, and an adder 2334 as shown in FIG. 7 to obtain the correlation value from the synchronization signal having the structure shown in FIG. 3.

The shift register 2331 corresponds to the synchronization signal inserted into the transmitted signal by the transmitter. The shift register 2331 consists of number (block length m×block number n) of registers. In other words, in the case of the synchronization signal shown in FIG. 3, the shift register 2331 consists of registers capable of the baseband signals equivalent to one cycle of synchronization signal shown in the figure or 24 chips.

Then, the shift register 2331 stores the baseband signals by an amount equivalent to one chip of synchronization signal, in each register. Each time the signals of one chip are newly input and stored, the shift register 2331 shifts the synchronization signal of one chip which has already been stored, to a register adjacent to the register which has already stored the synchronization signal, and outputs the signals of one chip stored in the registers to the multipliers 23331 to 2333q corresponding to the respective registers. In the case of FIG. 3, “q” indicates 24.

The replica code storing unit 2332 stores the synchronization code sequences used by the transmitter, i.e. number (block length m×block number n) of the synchronization code sequences shown in FIG. 3 as the replica codes, and outputs the replica codes to the multipliers 23331 to 2333q corresponding to the respective codes.

The multipliers 23331 to 2333q multiply the baseband signals of one chip output from the respective registers provided in the shift register 2331 and the replica codes stored in the replica code storing unit 2332, in synchronization with inputting the baseband signals of one chip to the shift register 2331, and outputs the multiplication result to the adder 2334.

The adder 2334 adds the multiplication results output from the respective multipliers 23331 to 2333q, and outputs the addition result to the control unit 20 as the correlation value of this time.

The control unit 20 controls the timing detecting unit 23 to urge the timing detecting unit 23 to obtain the correlation value in the replica base system or the delayed correlation base system. If the replica base system is employed, the control unit 20 urges the change-over switch 231 to select the replica base detection circuit 233. If the delayed correlation base system is employed, the control unit 20 urges the change-over switch 231 to select the delay detection circuit 232.

The criterion of selection of the two systems is based on, for example, the remaining amount of the battery of the receiver. If the remaining amount of the battery is small, the delayed correlation base system of small power consumption is selected. If the remaining amount of the battery is sufficient, the replica base system is selected.

The control unit 20 obtains a proportion of the peak of the correlation value obtained by the timing detecting unit 23 to the noise, and records the proportion in the memory unit 25. After executing this process for each of the transmitters, the control unit 20 specifies the transmitter of the best receiving quality on the basis of the proportion stored in the memory unit 25, detects the synchronization timing for receiving the signals from the transmitter, from the timing corresponding to the peak stored in the memory unit 25, and notifies the demapping unit 24 of this timing.

In addition, the control unit 20 executes the above-described detection of the synchronization timing in a case of establishing synchronization with the transmitter in the beginning of the communications as the initial synchronization or compensating for a synchronization timing shift caused by clock shift from the transmitter during the communications or during the standby time, or a case of changing the neighboring transmitter caused by the movement or the variation in the peripheral channels as the neighborhood search.

In the neighborhood search, the control unit 20 is notified of the reception signal intensity from each transmitter to some extent, from the previous synchronization process result. For this reason, the control unit 20 can detect the symbol timing with a sufficient accuracy at a low power consumption, by employing the delayed correlation base system which has a small power consumption but a comparatively poor synchronization performance, in the synchronization process with the transmitter which had a great reception strength at the previous time, on the basis of the previous synchronization process result, or by employing the replica base system which has a great power consumption but an excellent synchronization performance, in the synchronization process with the transmitter having a weak signal strength.

The demapping unit 24 demodulates the baseband signals at the timing notified from the control unit 20, demaps the signal obtained by the demodulation, and separates the demapped signal into the control signal, the phase reference signal and the data signal.

Next, the operation of detecting the synchronization timing at the receiver having the above-described configuration is described.

First, if the synchronization detection is executed in the replica base system using the conventional, general synchronization signal for synchronization detection shown in FIG. 8, a great autocorrelation peak appears outside the desired timing as shown in FIG. 9 since the synchronization signal is formed of components which continuously repeat the signal waveform. For this reason, since noise is added to the correlation value of each chip phase in the actual synchronization detection, obtaining a great autocorrelation at a wrong timing causes the synchronization performance to be deteriorated remarkably.

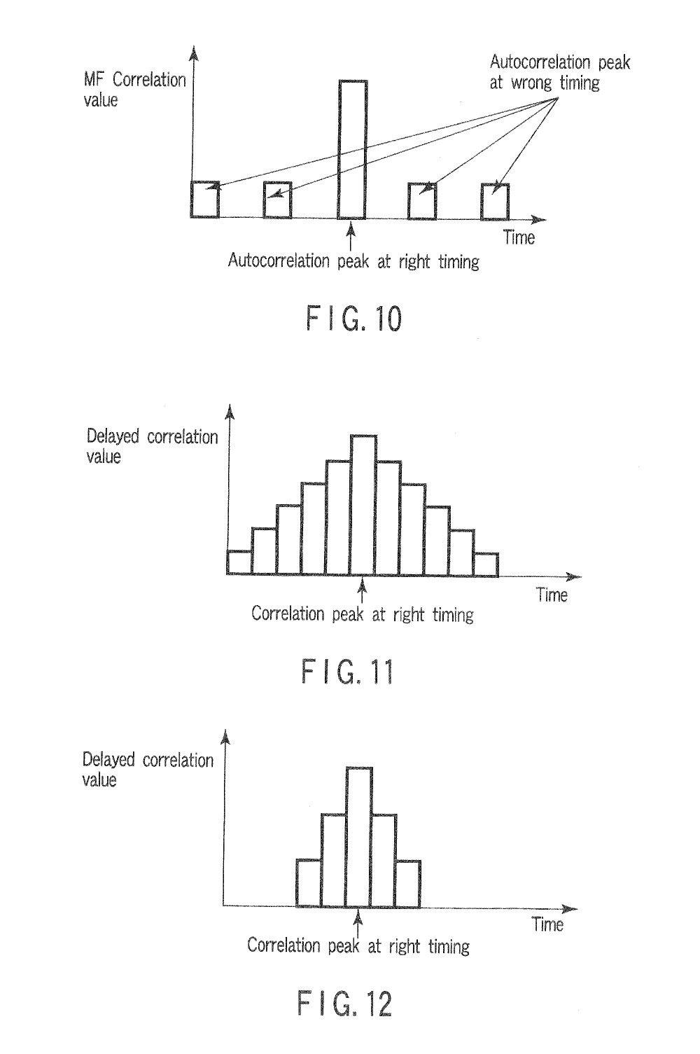

On the other hand, if the synchronization detection of the replica base system is executed by using the synchronization signal shown in FIG. 3, the autocorrelation peak at a wrong timing can be restricted as shown in FIG. 10, in inverse proportion to the total number of blocks, as compared with the synchronization signal shown in FIG. 8. In other words, in the synchronization signal shown in FIG. 3, the autocorrelation peak at a wrong timing is restricted to a half by doubling the number of blocks, as compared with the synchronization signal shown in FIG. 8. Since reducing the number of blocks causes complexity of the receiver to be increased, its merit can be obtained by determining the number of blocks in consideration of the synchronization performance and the tradeoff of the complexity of the receiver.

In the case of the delayed correlation base system, if the conventional, general synchronization signal for synchronization detection as shown in FIG. 8 is used and the synchronization detection in the delayed correlation base system is executed in a conventional structure corresponding to the synchronization signal, a mountain-shaped correlation peak appears about a desired timing as shown in FIG. 11.

On the other hand, if the synchronization signal shown in FIG. 3 is used and the synchronization detection in the delayed correlation base system is executed in a structure as shown in FIG. 6, a mountain-shaped correlation peak appears about a desired timing similarly to the conventional case as shown in FIG. 12 but becomes shaped in a steep-sided mountain as shown in FIG. 11 and the correlation peak at a wrong timing can be restricted.

In the radio communication system having the above-described configuration, the transmitter executes the transmission using the synchronization signal in which a plurality of blocks formed of the synchronization code sequences different from each other are aligned in the order changed in the former part and the latter part while the receiver comprises the delay detection circuit 232 corresponding to the delayed correlation base system and the replica base detection circuit 233 corresponding to the replica base system corresponding to the synchronization signal, to execute the synchronization detection selectively in the replica base system or the delayed correlation base system.

Thus, the transmitter can execute the transmission using the synchronization signal which corresponds to both the replica base system and the delayed correlation base system. The receiver can establish the synchronization in both the replica base system and the delayed correlation base system, and can restrict the correlation level at a wrong timing in either of the systems. Therefore, a high synchronization detection accuracy can be achieved.

The present invention is not limited to the embodiments described above but the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

For example, the receiver can establish synchronization in both the replica base system and the delayed correlation base system in the above-described embodiment, but may comprise the structure for either of the systems.

In addition, the receiver establishes synchronization in either of the replica base system and the delayed correlation base system in the above-described embodiment, but may obtain the chip phases in the respective systems and determined the synchronization timing on the basis of both the results.

The present invention can also be variously modified within a scope which does not depart from the gist of the present invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A mobile radio terminal in which a synchronization signal multiplexed on a transmission signal consists of at least four blocks A, B, C and D, timely preceding two blocks A and B consist of synchronization code sequences different from each other, two blocks C and D follow the blocks A and B, the block C consists of the same synchronization code sequence as the block B, the block D consists of the same synchronization code sequence as the block A, and reception is executed by establishing synchronization based on the synchronization signal,
the terminal comprising:
a first detecting unit which obtains a chip phase of a reception signal down-converted to a baseband, by delayed correlation, and detects a synchronization timing used for reception;
a second detecting unit which obtains the chip phase of the reception signal down-converted to the baseband, by a correlation with a prestored replica signal, and detects a synchronization timing used for reception; and
a control unit which selectively operates at least one of the first detecting unit and the second detecting unit.

2. The mobile radio terminal according to claim 1, wherein the first detecting unit comprises:
a shift register which consists of a plurality of registers and stores the reception signals in a chip unit;
a first delayed correlation detecting unit which obtains a correlation of chip phases of reception signals stored in two registers, respectively, corresponding to a difference in transmission timing of the same synchronization code sequences of the block A and the block D, of the reception signals stored in the shift register;
a second delayed correlation detecting unit which obtains a correlation of chip phases of reception signals stored in two registers, respectively, corresponding to a difference in transmission timing of the same synchronization code sequences of the block B and the block C, of the reception signals stored in the shift register; and
a synchronization detecting unit which detects the synchronization timing used for the reception, in accordance with peaks of the correlations obtained by the first delayed correlation detecting unit and the second delayed correlation detecting unit.

3. The mobile radio terminal according to claim 1, wherein the second detecting unit comprises:
a memory unit which preliminarily stores a replica signal of the synchronization signal;
a shift register which consists of a plurality of registers and stores the reception signals in a chip unit;
a correlation detecting unit which obtains a correlation of the replica signal stored in the memory unit and the reception signals stored in the shift register; and
a synchronization detecting unit which detects the synchronization timing used for the reception, in accordance with a peak of the correlation obtained by the correlation detecting unit.

4. A mobile radio terminal in which a synchronization signal multiplexed on a transmission signal consists of at least four blocks A, B, C and D, timely preceding two blocks A and B consist of synchronization code sequences different from each other, two blocks C and D follow the blocks A and B, the block C consists of the same synchronization code sequence as the block B, the block D consists of the same synchronization code sequence as the block A, and reception is executed by establishing synchronization based on the synchronization signal,
the terminal comprising:
a shift register which consists of a plurality of registers and stores the reception signals down-converted to a baseband, in a chip unit;
a first delayed correlation detecting unit which obtains a correlation of chip phases of reception signals stored in two registers, respectively, corresponding to a difference in transmission timing of the same synchronization code sequences of the block A and the block D, of the reception signals stored in the shift register;
a second delayed correlation detecting unit which obtains a correlation of chip phases of reception signals stored in two registers, respectively, corresponding to a difference in transmission timing of the same synchronization code sequences of the block B and the block C, of the reception signals stored in the shift register; and
a synchronization detecting unit which detects the synchronization timing used for the reception, in accordance with peaks of the correlations obtained by the first delayed correlation detecting unit and the second delayed correlation detecting unit.

5. A mobile radio terminal in which a synchronization signal multiplexed on a transmission signal consists of at least four blocks A, B, C and D, timely preceding two blocks A and B consist of synchronization code sequences different from each other, two blocks C and D follow the blocks A and B, the block C consists of the same synchronization code sequence as the block B, the block D consists of the same synchronization code sequence as the block A, and reception is executed by establishing synchronization based on the synchronization signal,
the terminal comprising:
a memory unit which preliminarily stores a replica signal of the synchronization signal;
a shift register which consists of a plurality of registers and stores the reception signals down-converted to a baseband, in a chip unit;
a correlation detecting unit which obtains a correlation of the replica signal stored in the memory unit and the reception signals stored in the shift register; and
a synchronization detecting unit which detects the synchronization timing used for the reception, in accordance with a peak of the correlation obtained by the correlation detecting unit.

6. A radio communication method in which a synchronization signal multiplexed on a transmission signal consists of at least four blocks A, B, C and D, timely preceding two blocks A and B consist of synchronization code sequences different from each other, two blocks C and D follow the blocks A and B, the block C consists of the same synchronization code sequence as the block B, the block D consists of the same synchronization code sequence as the block A, and reception is executed by establishing synchronization based on the synchronization signal,
the method comprising:
a first detecting step of obtaining a chip phase of a reception signal down-converted to a baseband, by delayed correlation, and detecting a synchronization timing used for reception;
a second detecting step of obtaining the chip phase of the reception signal down-converted to the baseband, by a correlation with a prestored replica signal, and detecting a synchronization timing used for reception; and
a control step of selectively operating at least one of the first detecting unit and the second detecting unit.

7. The method according to claim 6, wherein the first detecting step comprises:
a storing step of storing the reception signals in a chip unit by employing a shift register which consists of a plurality of registers;
a first delayed correlation detecting step of obtaining a correlation of chip phases of reception signals stored in two registers, respectively, corresponding to a difference in transmission timing of the same synchronization code sequences of the block A and the block D, of the reception signals stored in the shift register;
a second delayed correlation detecting step of obtaining a correlation of chip phases of reception signals stored in two registers, respectively, corresponding to a difference in transmission timing of the same synchronization code sequences of the block B and the block C, of the reception signals stored in the shift register; and
a synchronization detecting step of detecting the synchronization timing used for the reception, in accordance with peaks of the correlations obtained by the first delayed correlation detecting step and the second delayed correlation detecting step.

8. The method according to claim 6, wherein the second detecting step comprises:
a first storing step of preliminarily storing a replica signal of the synchronization signal;
a second storing step of storing the reception signals in a chip unit by employing a shift register which consists of a plurality of registers;
a correlation detecting step of obtaining a correlation of the replica signal stored in the first storing step and the reception signals stored in the shift register; and
a synchronization detecting step of detecting the synchronization timing used for the reception, in accordance with a peak of the correlation obtained by the correlation detecting step.

9. A radio communication method in which a synchronization signal multiplexed on a transmission signal consists of at least four blocks A, B, C and D, timely preceding two blocks A and B consist of synchronization code sequences different from each other, two blocks C and D follow the blocks A and B, the block C consists of the same synchronization code sequence as the block B, the block D consists of the same synchronization code sequence as the block A, and reception is executed by establishing synchronization based on the synchronization signal,
the method comprising:
a storing step of storing the reception signals down-converted to a baseband, in a chip unit, by employing a shift register which consists of a plurality of registers;
a first delayed correlation detecting step of obtaining a correlation of chip phases of reception signals stored in two registers, respectively, corresponding to a difference in transmission timing of the same synchronization code sequences of the block A and the block D, of the reception signals stored in the shift register;
a second delayed correlation detecting step of obtaining a correlation of chip phases of reception signals stored in two registers, respectively, corresponding to a difference in transmission timing of the same synchronization code sequences of the block B and the block C, of the reception signals stored in the shift register; and
a synchronization detecting step of detecting the synchronization timing used for the reception, in accordance with peaks of the correlations obtained by the first delayed correlation detecting step and the second delayed correlation detecting step.

10. A radio communication method in which a synchronization signal multiplexed on a transmission signal consists of at least four blocks A, B, C and D, timely preceding two blocks A and B consist of synchronization code sequences different from each other, two blocks C and D follow the blocks A and B, the block C consists of the same synchronization code sequence as the block B, the block D consists of the same synchronization code sequence as the block A, and reception is executed by establishing synchronization based on the synchronization signal,
the method comprising:
a first storing step of preliminarily storing a replica signal of the synchronization signal;
a second storing step of storing the reception signals in a chip unit by employing a shift register which consists of a plurality of registers;
a correlation detecting step of obtaining a correlation of the replica signal stored in the memory unit and the reception signals stored in the shift register; and
a synchronization detecting step of detecting the synchronization timing used for the reception, in accordance with a peak of the correlation obtained by the correlation detecting unit.
